(19) United States
(12) Patent Application Publication
(10) Pub. No.: US 2008/0168752 A1
(43) Pub. Date: Jul. 17, 2008

(54) SEPARATING PARTICULATE-CONTAINING GAS FLOW INTO PARTICULATE AND NON-PARTICULATE FLOW PORTIONS

(75) Inventors: T. Paul Smith, Oakhurst, NJ (US); Robert T. MacRae, Freehold, NJ (US); David J. Burke, Brick, NJ (US); Allan L. Budd, Sun City West, AZ (US); Tom A. Baldwin, Reno, NV (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: PERMA PURE, LLC, Toms River, NJ (US)

(21) Appl. No.: 11/949,834

(22) Filed: Dec. 4, 2007

Related U.S. Application Data
(60) Provisional application No. 60/871,537, filed on Dec. 22, 2006.

(51) Int. Cl. B01D 50/00

(52) U.S. Cl. 55/385.4

(57) ABSTRACT

In accordance with one embodiment of the present invention, an apparatus for separating a particulate-containing gas flow into particulate and substantially non-particulate flow portions is provided. The apparatus comprises a sample gas inlet, a radial separating ring, a separation draw, a separated gas outlet, a bypass eductor, and a bypass gas outlet. The radial separating ring comprises a separating ring gap defined between an inlet ring orifice and an outlet ring orifice, and is positioned such that a sample gas flow moving downstream from the sample gas inlet through the bypass eductor to the bypass gas outlet passes across the separating ring gap. The radial separating ring is configured such that the inlet ring orifice and the outlet ring orifice are relatively large, in relation to the size of the separating ring gap, and are positioned in close proximity to each other along the direction of the sample gas flow. The separation draw is configured to permit a substantially non-particulate portion of a sample gas flow moving across the separating ring gap to be drawn from the radial separating ring to the separated gas outlet.

### CROSS-REFERENCE TO RELATED APPLICATIONS

This application claims the benefit of U.S. Provisional Application Ser. No. 60/871,537 (PEP 0002 MA), filed Dec. 22, 2006.

### BRIEF SUMMARY

The present invention relates generally to particulate-containing gases and, more specifically, to methods and apparatuses for separating a particulate-containing gas flow into particulate and substantially non-particulate portions. In some embodiments of the present invention, the separation allows the non-particulate flow portion to be subject to constituent analysis. For example, and not by way of limitation, the concepts of the present invention can be used in stack sampling or other process analytical measurements where particles in the gaseous flow would interfere in some way with the analysis of the constituents-of-interest in the gaseous flow.

In the context of stack sampling, these constituents-of-interest can include, but are not limited to, elemental mercury, products of mercury, selenium, products of selenium, arsenic, products of arsenic, cadmium, products of cadmium, lead, products of lead, carbon containing compounds, C₆₀, isomers and derivatives of C₆₀, carbon dioxide, carbon monoxide, sulfur containing compounds, sulfur dioxide, sulfuric acid, nitrogen containing compounds, NOₓ, NO, NO₂, ammonia, ammonia-derived compounds, and other stack gas stream products or pollutants. In the more general context of process analytical measurements, including stack sampling, it is contemplated that the substantially non-particulate flow portion can be directed to a variety of analytical instruments including, but not limited to, FTIR and UV instruments, gas chromatographs, high resolution mass spectrometers, atomic absorption spectrometers, emission spectrometers, inductively coupled plasma emission spectrometers, inductively coupled plasma mass spectrometers, cold vapor atomic fluorescence spectrometry, gamma spectroscopy, and others.

In accordance with one embodiment of the present invention, an apparatus for separating a particulate-containing gas flow into particulate and substantially non-particulate flow portions is provided. The apparatus comprises a sample gas inlet, a radial separating ring, a separation draw, a separated gas outlet, a bypass eductor, and a bypass gas outlet. The radial separating ring comprises a separating ring gap defined between an inlet ring orifice and an outlet ring orifice, and is positioned such that a sample gas flow moving downstream from the sample gas inlet through the bypass eductor to the bypass gas outlet passes across the separating ring gap. The radial separating ring is configured such that the inlet ring orifice and the outlet ring orifice are relatively large, in relation to the size of the separating ring gap, and are positioned in close proximity to each other along the direction of the sample gas flow. The separation draw is configured to permit a substantially non-particulate portion of a sample gas flow moving across the separating ring gap to be drawn from the radial separating ring to the separated gas outlet.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIG. 1 is a schematic illustration of a separating apparatus according to an embodiment of the present invention where the apparatus comprises a separating block and a bypass block;

FIG. 2 is an illustration of a portion of a radial separating ring according to one aspect of the present invention;

FIG. 3 is an additional schematic illustration of the separating block illustrated in FIG. 1;

FIG. 4 is an illustration of a portion of a bypass eductor according to one aspect of the present invention; and

FIG. 5 is a schematic illustration of a separating apparatus according to an embodiment of the present invention where the separating apparatus is positioned in the interior of an exhaust stack.

### DETAILED DESCRIPTION

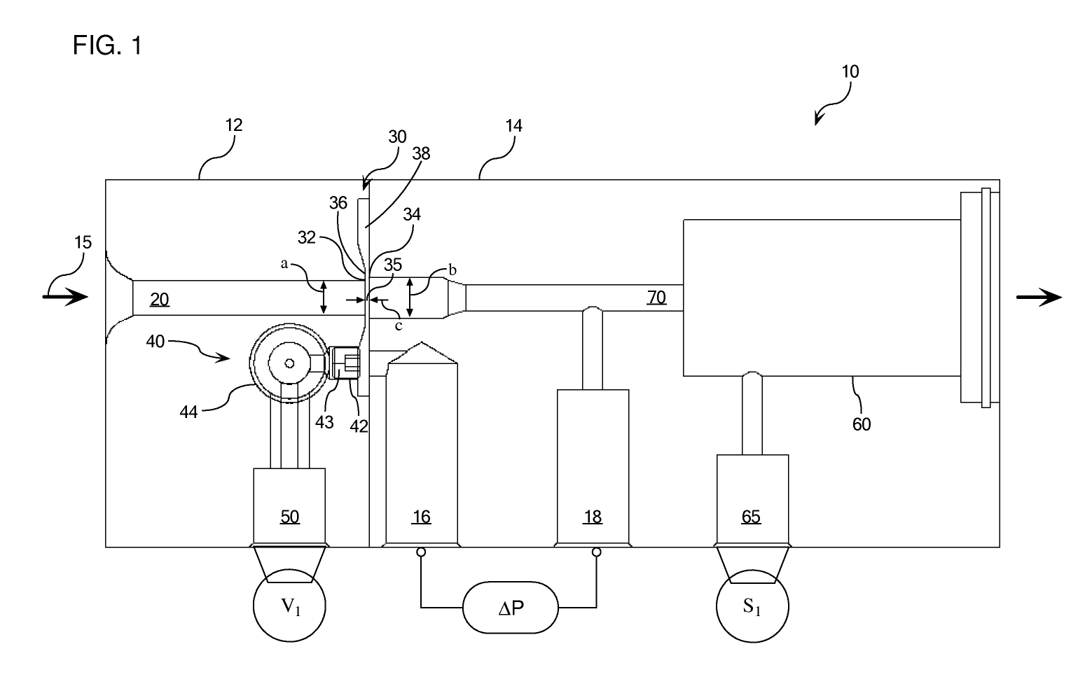

Referring initially to FIG. 1, an apparatus 10 for separating a particulate-containing gas flow into particulate and substantially non-particulate flow portions is illustrated. As is noted above, particulate matter can interfere with the analysis of target constituents in a given gas flow. The separating apparatus 10 illustrated in FIG. 1 comprises a sample gas inlet 20, a radial separating ring 30, a separation draw 40, a separated gas outlet 50, a bypass eductor 60, and a bypass gas outlet 70. Collectively, these components are configured to use momentum to remove all but the very finest particles from a sample gas flow 15. Generally, the operation of the separating apparatus 10 is based on the principle that the undesirable particles in the sample gas flow 15 will have higher inertia than the target constituents to be analyzed.

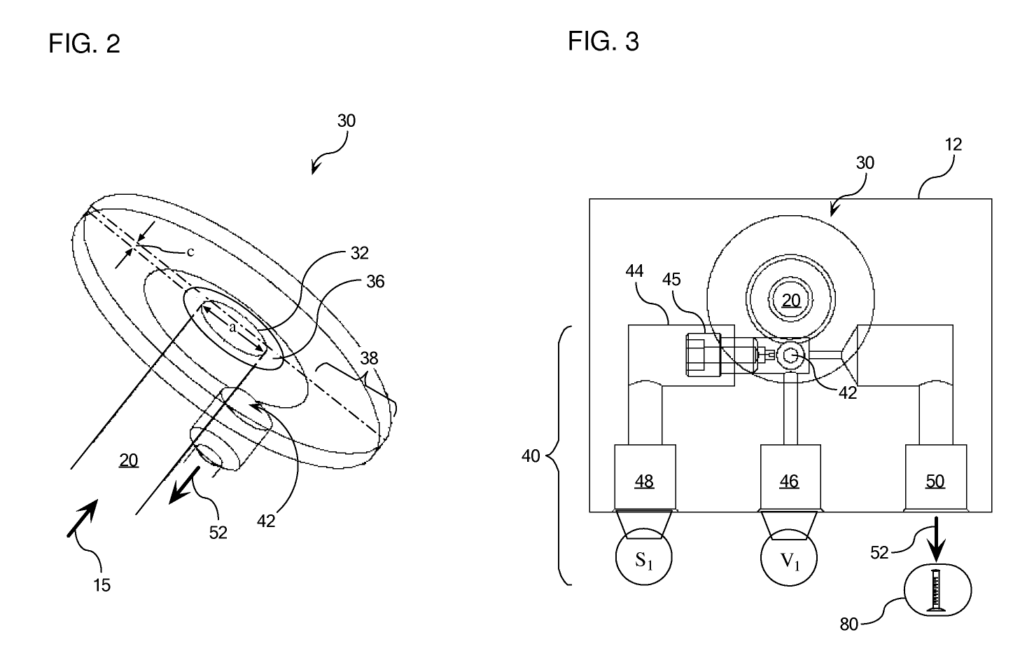

In operation, the bypass eductor 60 induces a sample gas flow 15 moving downstream from the sample gas inlet 20, through the bypass eductor 60, to the bypass gas outlet 70. The bypass eductor 60 is illustrated without significant detail in FIG. 1 because it is contemplated that any of a variety of existing and yet to be developed eductor designs may be employed in practicing the present invention. The radial separating ring 30, which is illustrated in further detail in FIG. 2, comprises a separating ring gap 35 defined between an inlet ring orifice 32 and an outlet ring orifice 34 and is positioned such that the downstream sample gas flow 15 passes across the separating ring gap 35 on its way to the bypass gas outlet 70.

Referring collectively to FIGS. 1 and 2, the separation draw is configured such that, in operation, a substantially non-particulate portion of the sample gas flow 15 moving across the separating ring gap 35 is drawn from the radial separating ring 30 and is directed to the separated gas outlet 50 as a separated gas flow 52. To help ensure proper separation of the particulate-containing gas flow into particulate and substantially non-particulate flow portions, the radial separating ring 30 is configured such that the inlet ring orifice 32 and the outlet ring orifice 34 are relatively large, in relation to the size of the separating ring gap 35, and are positioned in close proximity to each other along the direction of the sample gas flow 15. More specifically, the radial separating ring 30 is configured such that the inlet ring orifice 32, the outlet ring orifice 34, and the separating ring gap 35 satisfy the following relations:

b≧a≧2c

c≦1500 μm

where a represents the size of the inlet ring orifice across the downstream sample gas flow 15, b represents the size of the outlet ring orifice across the downstream sample gas flow 15, and c represents the size of the separating ring gap in the direction of the downstream sample gas flow 15.

In addition, as is illustrated in FIG. 1, the radial separating ring 30 is configured such that the substantially non-particulate portion of the sample gas flow 15 moving across the separating ring gap 35 is drawn in a direction that is substantially orthogonal to the direction of the sample gas flow 15. The present inventors have recognized that this type of configuration is likely to minimize eddy currents in the vicinity of the radial separating ring and, as such, discourage redirection of relatively massive, undesirable particles through the separating ring 30. For example, and not by way of limitation, to establish a separating ring draw characterized by a flow that is predominantly orthogonal to the sample gas flow 15, it is contemplated that the radial separating ring gap 35 can be configured to extend in the substantially orthogonal direction for at least approximately 40 μm beyond the bounds of the inlet ring orifice 32. Suitable structure for encouraging this type of orthogonal flow is illustrated in detail in FIG. 2, where the inlet side of the separating ring 30 is illustrated and comprises an inlet mesa 36 surrounding the inlet ring orifice 32.

FIGS. 1 and 2 also illustrate in detail the configuration of the separating ring 30. As is noted above, the radial separating ring 30 is configured such that the inlet ring orifice 32 and the outlet ring orifice 34 are relatively large, in relation to the size of the separating ring gap 35, and are positioned in close proximity to each other along the direction of the sample gas flow 15. For example, and not by way of limitation, the inlet ring orifice 32 and the outlet ring orifice 34 are typically aligned along a common axis extending in the direction of the downstream sample gas flow 15 and the size c of the separating ring gap 35 in the direction of the sample gas flow 15 can be between approximately 250 μm and approximately 1500 μm or, more particularly, between approximately 400 μm and approximately 800 μm. The size a of the inlet ring orifice 32 across the downstream sample gas flow 15 can be between approximately 3200 μm and approximately 9500 μm. The size b of the outlet ring orifice 34 across the downstream sample gas flow 15 can be approximately equal to the size a of the inlet ring orifice 32 across the downstream sample gas flow 15 or as much as approximately 500 μm greater than the size a of the inlet ring orifice 32.

It is contemplated that the separating apparatus according to the present invention may be fabricated from two component blocks, which may be referred to as a separating block 12 and a bypass block 14. As is illustrated in FIG. 1, the separating block 12 comprises the separation draw 40 and the bypass block comprises the bypass eductor 60. In addition, the separating block 12 forms the inlet ring orifice 32, the bypass block 14 defines the outlet ring orifice 34, and the two blocks 12, 14 interface to collectively form the radial separating ring 30.

FIG. 3 presents a detailed illustration of the separating block 12 from the perspective of the sample gas inlet 20. As is illustrated in FIG. 3, the separation draw 40 may comprise a draw port 42, a separating eductor 44, and a vacuum port 46. The separating eductor 44 can be formed by providing a dilution gas inlet 48 and metering nozzle 45 in communication with the separated gas outlet 50 and the draw port 42. Although the separation draw 40 is illustrated herein as comprising a separating eductor 44, it is contemplated that the separation draw 40 may comprise any type of conventional or yet to be developed configuration for creating a pressure differential that will draw a portion of the sample gas flow 15 through the radial separating ring 30, and the draw port 42 to the separated gas outlet 50.

As is illustrated in FIGS. 1 and 2, the draw port 42 is positioned in an expanded volumetric portion 36 of the radial separating ring 30 to improve the uniformity of the draw. It is contemplated that the separation draw 40 may comprise a plurality of draw ports arranged symmetrically in the radial separating ring 30 to further improve the uniformity of the draw. It is further contemplated that a threaded, adjustable metering nozzle 43 may be provided in the draw port 42 to help control the flow rate of the draw. For example, and not by way of limitation, it is contemplated that the separating apparatus 10 can be configured to withdraw approximately 10% of sample gas flow 15 at a flow rate of approximately 5 L/min.

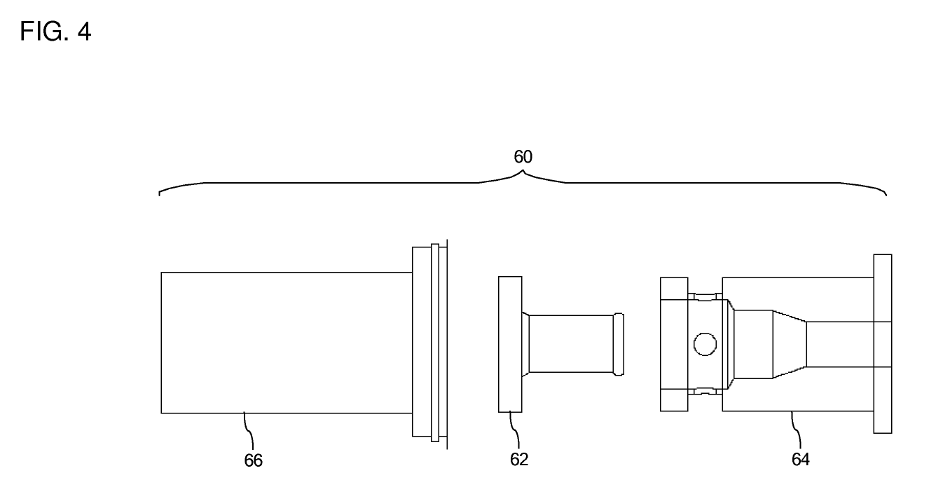

The bypass block 14 comprises the bypass eductor 60 and may further comprise upstream and downstream bypass block ports 16, 18 that may be utilized for a variety of purposes. For example, the upstream and downstream bypass block ports 16, 18 may be placed in communication with a differential pressure sensor ΔP to act as a venturi flowmeter. The upstream bypass block port 16 may also be used to supply a purge gas that can be used at start-up or a calibration gas that can be used to calibrate the separating apparatus 10 and any sensing or analysis equipment used therewith. It is also contemplated that additional ports may be provided in the bypass block 14 to accommodate one or more temperature probes. Although it is noted above that a variety of eductor designs may be employed in practicing the present invention, an example of one suitable eductor design 60 is illustrated in FIG. 4 and comprises an eductor nozzle 62 and an eductor outlet 64, each of which is positioned inside an eductor cavity 66 formed in the bypass block 14.

The separating apparatus 10 may be assembled to further comprise a flow control system in communication with the various ports described herein. For example, in the illustrated embodiment, the separating apparatus 10 comprises a bypass eductor supply S₁ in communication with the bypass eductor 60 via an eductor port 65, a dilution gas supply S₂ in communication with the separation draw 40 via a draw port 42, and a draw vacuum V₁ in communication with the separation draw 40 via a vacuum port 46.

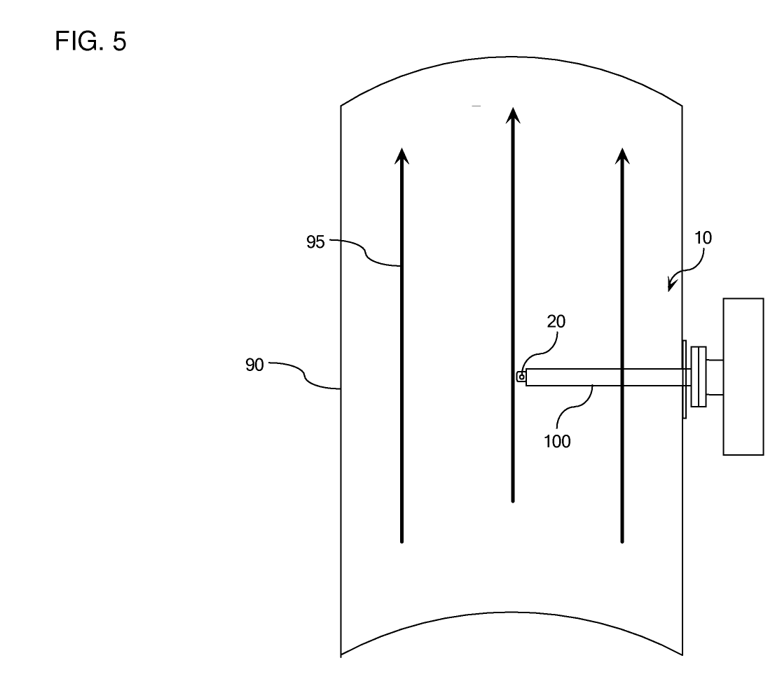

In operation as part of a gas analysis system, the separating apparatus 10 may further comprise a gas analyzer 80 in direct or indirect communication with the separated gas outlet 50. For stack sampling applications, as is illustrated in FIG. 5, the sample gas inlet 20 and the bypass gas outlet 70 are positioned in the interior of an exhaust stack 90. A probe extension 100 is mounted to the exhaust stack 90 so as to position the sample gas inlet 20 and the bypass gas outlet 70 in a flow of particulate-containing exhaust 95 at an inward radial position of the exhaust stack 90 so that downstream direction of the sample gas flow 15 is orthogonal to the flow direction of the exhaust 95, although the sample gas flow direction may be aligned with the flow direction of the exhaust 95. Alternatively, the sample gas inlet 20 and the bypass gas outlet 70 may be positioned in a diverted exhaust path external to the interior of the exhaust stack 90.

It is noted that various aspects of the present invention will be particularly useful in the stack sampling environment, where particulate contamination is profound. More specifically, it is noted that various embodiments of the present invention will be so effective in removing non-particulate portions of a particulate sample gas flow, that it will typically not be necessary to utilize any filter elements in the separated gas flow. As a result, aspects of the present invention can be utilized to reduce maintenance costs of monitoring systems and of process analytical measurements.

It is noted that recitations herein of a component of the present invention being “configured” in a particular way or to embody a particular property, or function in a particular manner, are structural recitations as opposed to recitations of intended use. More specifically, the references herein to the manner in which a component is “configured” denotes an existing physical condition of the component and, as such, is to be taken as a definite recitation of the structural characteristics of the component.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present invention or to emphasize alternative or additional features that may or may not be utilized in a particular embodiment of the present invention.

For the purposes of describing and defining the present invention it is noted that the terms “substantially” and “approximately” are utilized herein to represent the inherent degree of uncertainty that may be attributed to any quantitative comparison, value, measurement, or other representation. The terms “substantially” and “approximately” are also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

1. An apparatus for separating a particulate-containing gas flow into particulate and substantially non-particulate flow portions, the apparatus comprising a sample gas inlet, a radial separating ring, a separation draw, a separated gas outlet, a bypass eductor, and a bypass gas outlet, wherein:
the radial separating ring comprises a separating ring gap defined between an inlet ring orifice and an outlet ring orifice, and is positioned such that a sample gas flow moving downstream from the sample gas inlet through the bypass eductor to the bypass gas outlet passes across the separating ring gap;
the radial separating ring is configured such that the inlet ring orifice, the outlet ring orifice, and the separating ring gap satisfy the following relations
b≧a≧2c
c≦1500 μm
where a represents the size of the inlet ring orifice across the downstream sample gas flow, b represents the size of the outlet ring orifice across the downstream sample gas flow, and c represents the size of the separating ring gap in the direction of the downstream sample gas flow; and
the separation draw is configured to permit a substantially non-particulate portion of a sample gas flow moving across the separating ring gap to be drawn from the radial separating ring to the separated gas outlet.

2. A separating apparatus as claimed in claim 1 wherein the radial separating ring is configured such that the substantially non-particulate portion of a sample gas flow moving across the separating ring gap is drawn in a direction substantially orthogonal to the direction of the sample gas flow.

3. A separating apparatus as claimed in claim 2 wherein the radial separating ring gap extends in the substantially orthogonal direction for at least approximately 40 μm beyond the bounds of the inlet ring orifice to establish a separating ring draw characterized by a flow that is predominantly orthogonal to the sample gas flow.

4. A separating apparatus as claimed in claim 1 wherein the size c of the separating ring gap in the direction of the downstream sample gas flow is between approximately 400 μm and approximately 800 μm.

5. A separating apparatus as claimed in claim 1 wherein the size a of the inlet ring orifice across the downstream sample gas flow is between approximately 3200 μm and approximately 9500 μm.

6. A separating apparatus as claimed in claim 1 wherein the size b of the outlet ring orifice across the downstream sample gas flow is up to approximately 80 μm greater than the size a of the inlet ring orifice across the downstream sample gas flow.

7. A separating apparatus as claimed in claim 1 wherein:
the size c of the separating ring gap in the direction of the downstream sample gas flow is between approximately 400 μm and approximately 800 μm;
the size a of the inlet ring orifice across the downstream sample gas flow is between approximately 3200 μm and approximately 9500 μm; and
the size b of the outlet ring orifice across the downstream sample gas flow is up to approximately 80 μm greater than the size a of the inlet ring orifice across the downstream sample gas flow.

8. A separating apparatus as claimed in claim 1 wherein the inlet ring orifice and the outlet ring orifice are aligned along a common axis extending in the direction of the downstream sample gas flow.

9. A separating apparatus as claimed in claim 1 wherein:
the separating apparatus comprises a separating block and a bypass block;
the separating block comprises the separation draw;
the bypass block comprises the bypass eductor; and
the separating block and the bypass block interface to collectively form the radial separating ring.

10. A separating apparatus as claimed in claim 9 wherein the separating block defines the inlet ring orifice and the bypass block defines the outlet ring orifice.

11. A separating apparatus as claimed in claim 1 wherein the separation draw comprises at least one draw port in the radial separating ring.

12. A separating apparatus as claimed in claim 11 wherein the draw port is positioned in an expanded volumetric portion of the radial sampling ring.

13. A separating apparatus as claimed in claim 1 wherein the separation draw comprises a plurality of draw ports arranged symmetrically in the radial separating ring.

14. A separating apparatus as claimed in claim 1 wherein the separation draw comprises a separating eductor, a vacuum port, and a dilution gas inlet in communication with the separated gas outlet.

15. A separating apparatus as claimed in claim 1 wherein the separating apparatus further comprises a flow control system comprising a bypass eductor supply S₁ in communication with the bypass eductor and a draw vacuum V₁ in communication with the separation draw.

16. A separating apparatus as claimed in claim 15 wherein the flow control system further comprises a dilution gas supply S₂ in communication with the separation draw.

17. A separating apparatus as claimed in claim 15 wherein the flow control system further comprises a differential pressure sensor in communication with fluid porting downstream of the separation draw.

18. A separating apparatus as claimed in claim 15 wherein the flow control system further comprises a source of calibration or purge gas in communication with fluid porting downstream of the separation draw.

19. A separating apparatus as claimed in claim 1 wherein the separating apparatus further comprises a gas analyzer in communication with the separated gas outlet.

20. A separating apparatus as claimed in claim 1 wherein the sample gas inlet and the bypass gas outlet are positioned in the interior of an exhaust stack.

21. A separating apparatus as claimed in claim 19 wherein the separating apparatus further comprises a probe extension mounted to the exhaust stack so as to position the sample gas inlet and the bypass gas outlet at an inward radial position of the exhaust stack.

22. A separating apparatus as claimed in claim 1 wherein the sample gas inlet and the bypass gas outlet are positioned in a diverted exhaust path external to the interior of an exhaust stack.
